(19) United States
(12) Patent Application Publication
(10) Pub. No.: US 2008/0012494 A1
(43) Pub. Date: Jan. 17, 2008

(54) Plasma display panel

(75) Inventors: Chao-Hung Hsu, Padeh City (TW); Po-Nien Chen, Padeh City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CHUNGHWA PICTURE TUBES, LTD

(21) Appl. No.: 11/486,022

(22) Filed: Jul. 14, 2006

(51) Int. Cl. H01J 17/49

(52) U.S. Cl. 313/585; 313/582

(57) ABSTRACT

The display electrode of plasma display panel includes transparent electrodes made by Indium Tin Oxide and auxiliary electrodes made by metal. Transparent electrode induces gas discharge to excite the phosphorus to emit the visible ray. Auxiliary electrode decreases the aperture area of a cell to decrease the ratio of the light of the cell in a pixel. On the transparent electrode a protrusion protruded into a cell would increase the luminous intensity of the cell, and on the auxiliary electrode decrease the luminous rate of the cell. Validly designed protrusions on transparent electrodes or on auxiliary electrodes in a pixel would get better luminous intensity and rise up the color temperature.

### BACKGROUND OF THE INVENTION

1. Field of the Invention

The present invention relates to a plasma display panel, especially, to the display electrodes boosting the color temperature of a plasma display panel.

2. Background of the Related Art

Plasma display panel (hereafter noted PDP) excites internal phosphorous layer to irradiate light. A voltage on the display electrodes of PDP ionizes inert gases filled inside PDP, and then the ionized inert gases emit ultraviolet to stimulate the phosphorous layer to irradiate visible light.

FIG. 1 is a schematic diagram to explain the structure of the PDP. For convenience to illustrate the PDP, the rows and columns are defined. A PDP includes a front panel and a rear panel. The front panel includes a glass substrate 100, a dielectric layer 200 and a protective layer 300. Display electrodes are parallel and discrete formed on the glass substrate 100 along the rows, and each display electrode includes a pair of electrodes. Each of the pair electrodes includes a transparent electrode made by Indium Tin Oxide (ITO) and a metallic auxiliary electrode (BUS), that is, one of the pair of electrodes includes a common electrode 210 and an auxiliary electrode 230 formed on the common electrode 210, and the other includes a scan electrode 220 and an auxiliary electrode 240 formed on the scan electrode 220. The dielectric layer 200 and the protective layer 300 are formed subsequently on glass substrate to cover display electrodes.

Rear panel includes a glass substrate 600, a dielectric layer 500 and barrier ribs 410 (RIBs). Address electrodes 510 are parallel and discrete formed on the glass substrate 600 along the columns, and then dielectric layer 500 is formed to cover the address electrodes 510. Between two adjacent address electrodes 510, barrier ribs 410 are formed on dielectric layer 500. Phosphorous layers 420 cover the space between two adjacent barrier ribs 410.

When rear panel and front panel are set, inert gases fill the space between two adjacent barrier ribs 410. Display electrodes on the front substrate and address electrodes 510 on the rear substrate intersect each other, and each intersection defines a cell between two adjacent barrier ribs 410 and display electrodes. Three sequential cells with red, green and green phosphorous layer form a pixel.

FIG. 2 is a color temperature coordinates 700 illustrating the color temperature distribution. The points 710, 720, 730 and 740 are the white, red, green and blue color temperatures respectively. The formula W(x,y)=r×R(x,y)+g×G(x,y)+b×B(x,y) shows the color temperature distribution, where W(x,y), R(x,y), G(x,y) and B(x,y) are white, red, green and blue color temperatures at the point (x,y) on the color temperature coordinates respectively, and r, g, and b are the intensities of red, green and blue colors respectively. According to the formula to modify the ratio and boost the intensities of cells in a pixel will obtain a higher color temperature of a display.

FIG. 3 is a sectional diagram of a cell illustrating the principle of the luminance, for better understanding, the display electrode is rotated 90 degree. The common electrode 210 and scan electrode 220 are energized to induce a chain reaction of the inert gases. Recombination of the inert ions emits ultraviolet to excite the phosphorous layer 420 to irradiate the visible light.

FIG. 4 shows a sectional diagram of a pixel in PDP provided in U.S. Pat. No. 6,838,825, where the display electrodes are rotated 90 degree for convenience to better understanding. The sizes of cells in a pixel are different to better the ratio to obtain the higher color temperature. In generally, red and green cells are small and hard to address, and the asymmetry structure is difficult to manufacture.

FIG. 5 shows a sectional diagram of a cell in PDP provided in U.S. Pat. No. 6,867,545, where the display electrode is rotated 90 degree for convenience to better understanding. It is different from FIG. 3 black stripes 250 are formed at marginal area of a cell and on the barrier ribs. The black stripe on a cell modifies the ratio of intensity of the cell in a pixel to reach high color temperature, but it decreases the intensity of the cell.

FIG. 6 is a top perspective diagram of a pixel 800 in PDP provided by U.S. Pat. No. 6,255,779, where the auxiliary electrodes 230,240 and transparent electrodes 210,220 are discrete and connected by sticks 232,242 protruded from the auxiliary electrodes, and the auxiliary are made narrower than the auxiliary electrodes showing in FIG. 3. This structure increases the intensity of the light but does not cope with the color temperature.

A total solution to increase the color temperature and intensity of light is an important topic in PDP.

### SUMMARY OF THE INVENTION

A display electrode includes two parts: one is transparent and the other called auxiliary electrode is opaque. The transparent electrodes induce ultraviolet to arise the intensity, and the auxiliary electrodes narrow the aperture of the cell in a pixel. Validly designed protrusions protruded from the transparent and/or auxiliary electrodes reach the high luminous intensity and high color temperature.

An embodiment of this present invention is to form protrusions from transparent electrodes to induce more ultraviolet of the cell in a pixel, that is, the protrusions arise the luminous intensity of the cell in a pixel.

The other embodiment of the present invention is to form protrusions from auxiliary electrodes to narrow the aperture of the cell, that is, the protrusions depress the ratio of the cell in a pixel. By the way, the protrusions modify the red, green and/or blue luminance to obtain higher color temperature of the pixel.

Aforementioned, the cells of a PDP do not need to be made different size to make the difficult in manufacturing process, or black stripes beside the cell above the barrier ribs to sacrifice the luminous intensity to reach the high color temperature.

Another object of the present invention is to address more easily. The area of the auxiliary electrodes on scan electrode is larger, so scan and address electrodes couple with each other more easily.

### BRIEF DESCRIPTION OF THE DRAWINGS

FIG. 1 is a respective diagram showing the conventional structure of a plasma display panel in a prior art.

FIG. 2 is a diagram showing the conventional color temperature coordinates in a prior art.

FIG. 3 shows the sectional diagram of a conventional cell in conventional plasma display panel.

FIG. 4 shows the sectional diagram of a conventional pixel in conventional plasma display panel.

FIG. 5 shows the sectional diagram of a conventional cell in conventional plasma display panel.

FIG. 6 shows the top schematic diagram of a conventional pixel in conventional plasma display panel.

FIG. 7 is a top schematic diagram illustrating the structure of a cell according to an embodiment of this present invention.

FIG. 8 is a top schematic diagram illustrating the structure of a cell according to an embodiment of the present invention.

FIG. 9 is a top schematic diagram illustrating the structure of a pixel according to an embodiment of the present invention.

FIG. 10 is a sectional diagram illustrating structure of a cell according to FIG. 9 cut by the line EE′.

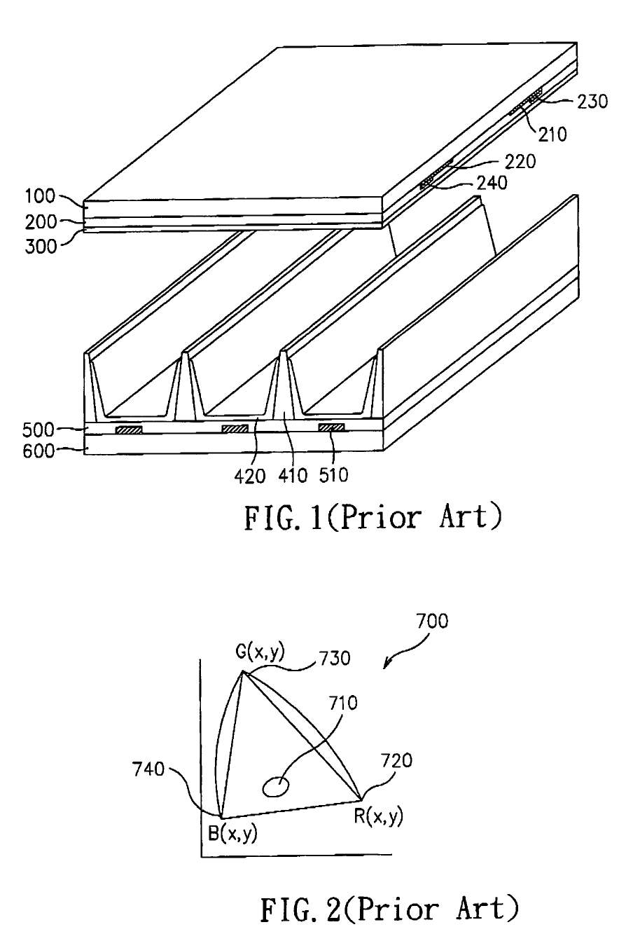

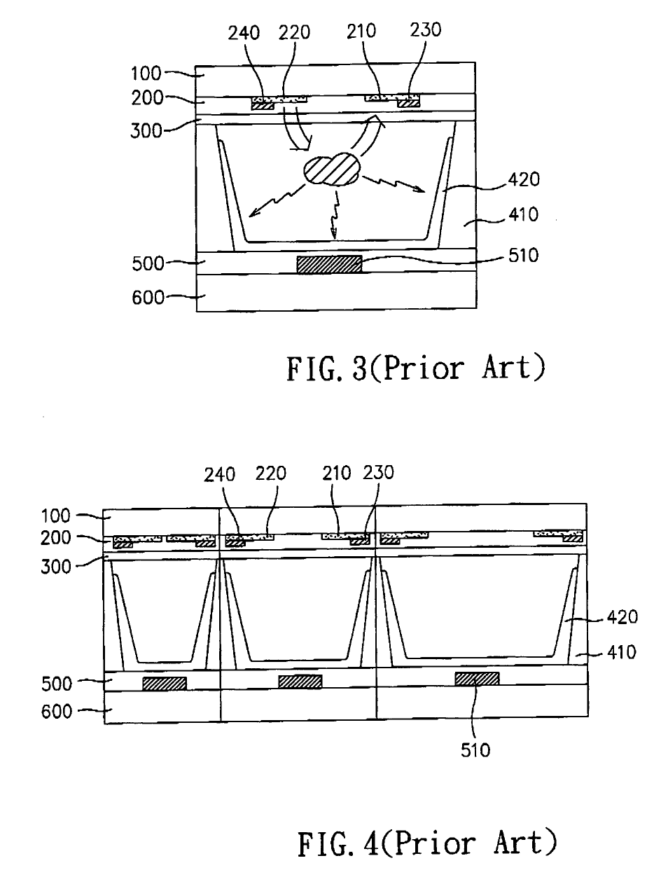

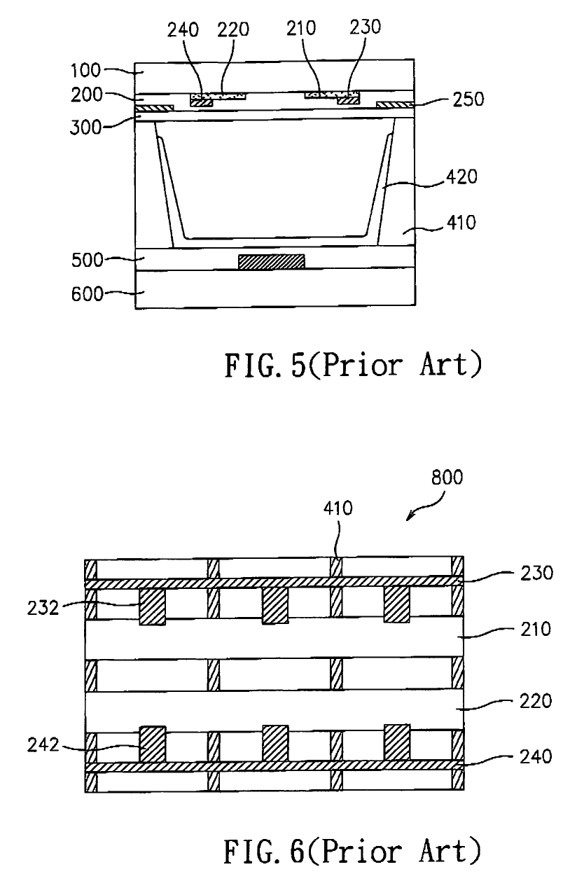

### DETAILED DESCRIPTION OF THE INVENTION

A plasma display panel (hereafter noted PDP) uses the ions recombination to emit the ultraviolet to stimulate phosphorous layer irradiate the visible light. A pixel includes three cells red, green and blue. To increase the color temperature has to increase the intensity of light and mix properly the colors red, green and blue according to the color combination rule of the National Television System Committee (hereafter noted NTSC). For general PDPs, to reduce ratio of the red and green and to increase ratio of the blue reaches higher color temperature.

The display electrodes of a PDP includes transparent electrodes made generally by conductive Indium Tin Oxide (ITO) and auxiliary electrodes made generally by metal. The transparent electrodes induce and increase the intensity of light and the auxiliary electrodes reduce the aperture ratio of the cell in a pixel. The properly designed area of the transparent and auxiliary electrodes over on cells of a pixel will arise the color temperature of PDP.

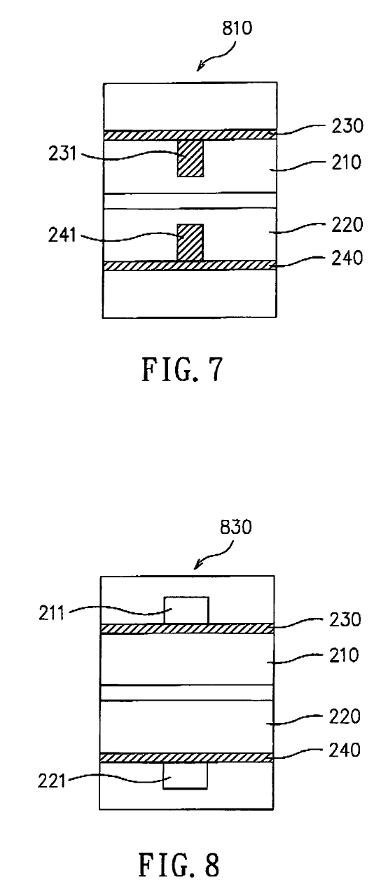

FIG. 7 is a top schematic diagram showing the structure of a cell 810 according to an embodiment of this present invention. On the plane of a cell, auxiliary electrodes 230, 240 are formed on and aligned beside the transparent electrodes, and transparent electrodes include a common electrode 210 and a scan electrode 220 away from and parallel to the common electrode 210. The protrusions 231, 241 from auxiliary electrodes 230, 240 project into the center of the cell 810.

Auxiliary electrodes are made by metal, in generally, by chromium/chromium/cooper or silver. The protrusions 231, 241 from the auxiliary electrodes 230, 240 enlarge the area of the opaque to reduce the ratio of the cell in a pixel. The shape of the protrusions is not limited, maybe a triangle, a square or a circle, but the ratio of the opaque to the transparent area is fixed.

FIG. 8 is a top schematic diagram showing the structure of a cell 830 according to another embodiment of this present invention. On the plane of a cell, auxiliary electrodes 230, 240 are formed on and aligned beside the transparent electrodes, and transparent electrodes include the common electrode 210 and scan electrode 220 away from and parallel to the common electrode 210. The protrusions 211, 221 from transparent electrodes 210, 220 project into the upside and downside of the cell 810.

In generally, Indium Tin Oxide (ITO), it is conductive, forms transparent electrodes on substrate. The protrusions 211, 221 of the transparent electrodes 210, 220 inspire the luminance to increase the color intensity of the cell in a pixel. The shape of the protrusions is not limited, maybe a triangle, a square or a circle, but area is predetermined according to the color combination and the inductive performance of ITO.

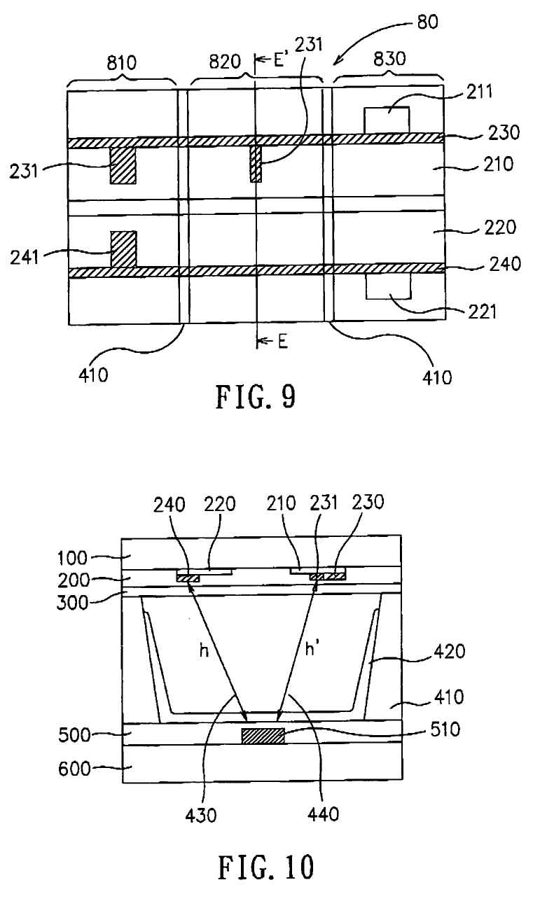

FIG. 9 is a top schematic diagram showing the structure of a pixel 80 according to an embodiment of this present invention. The barrier ribs 410 on the rear substrate divide the pixel into three parts and the display electrodes including transparent electrodes 210, 220 and auxiliary electrodes 230, 240 cross over the pixel, and the intersection points address cells 810,820, 830. The protrusions 211, 221 protruded from transparent electrodes 210, 220 induce the luminous intensity to increase the color weight of the cell 830, and the protrusions 231, 241 protruded from auxiliary electrodes 230, 240 reduce the ratio to decrease the color weight of the cells 810, 820 in the pixel 80. Validly designed ratio of the areas of the protrusions from transparent and auxiliary electrodes reaches the higher color temperature.

For examples, to decrease the color weight of the red and green and to increase that of the blue should reach high color temperature in PDP according to the NTSC. The protrusions from auxiliary electrodes over red and green cells and from the transparent electrodes over blue cell in a pixel are formed, and a valid ratio of the areas of the protrusions in different cells will reach high color temperature and high luminance performance.

FIG. 10 is a sectional diagram of the cutting line EE′ of the FIG. 9 illustrating the structure of a cell, and for better understanding, the display electrode is rotated 90 degree. The diagram is employed to explain the difference between the conventional and current design according to the present invention. The distance 430 (h) between the auxiliary electrode 240 on the front glass substrate 100 and the address electrode 510 on the rear glass substrate 600 is the distance in conventional art, and the distance 440 (h′) between the protrusion 231 protruded from the auxiliary electrode 230 and the address electrode 510 is the distance. The relation h′<h presents the area of the auxiliary electrode over the cell increases, and subsequently the cell is addressed more easily.

Although the present invention has been explained in relation to its preferred embodiment, it is to be understood that other modifications and variation can be made without departing the spirit and scope of the invention as claimed.

What is claimed is:

1. A plasma display panel with defined rows and columns comprising a front panel including a plurality of display electrodes discretely aligned along the rows, a rear panel including a plurality of address electrodes discretely aligned along the columns, a space filled by inert gases between the said front and said rear panels, barrier ribs formed on said rear panel dividing said space into cells around the intersections of said display electrodes and said address electrodes, phosphorous layers with a specified order in red, green and blue on the rear panel and between two adjacent said barrier ribs, wherein serial red, green and blue cells form a pixel, and characterized by each of said display electrodes on said front panel over one pixel comprising:
a first and second transparent electrodes parallel to and away from each other;
a first and second auxiliary electrodes formed on said first and second transparent electrodes respectively; and
at least a protrusion protruded from at least one of said auxiliary electrodes over cells.

2. The plasma display panel according to claim 1, wherein said protrusions over two cells and from said auxiliary electrodes in a pixel are same or different.

3. The plasma display panel according to claim 1, wherein protrusions from said auxiliary electrodes over three cells in a pixel are same or different.

4. A plasma display panel with defined rows and columns comprising a front panel including a plurality of display electrodes discretely aligned along the rows, a rear panel including a plurality of address electrodes discretely aligned along the columns, a space filled by inert gases between the said front and said rear panels, barrier ribs formed on said rear panel dividing said space into cells around the intersections of said display electrodes and said address electrodes, phosphorous layers with a specified order in red, green and blue on the rear panel and between two adjacent said barrier ribs, wherein serial red, green and blue cells form a pixel, and characterized by each of said display electrodes on said front panel over one pixel comprising:
a first and second transparent electrodes parallel to and away from each other;
a first and second auxiliary electrodes formed on said first and second transparent electrodes respectively; and
at least a protrusion protruded from at least one of said transparent electrodes over cells.

5. The plasma display panel according to claim 4, wherein said protrusions from said transparent electrodes over two cells in a pixel are same or different.

6. The plasma display panel according to claim 4, wherein said protrusions from said transparent electrodes over three cells in a pixel are same or different.

7. A plasma display panel with defined rows and columns comprising a front panel including a plurality of display electrodes discretely aligned along the rows, a rear panel including a plurality of address electrodes discretely aligned along the columns, a space filled by inert gases between the said front and said rear panels, barrier ribs formed on said rear panel dividing said space into cells around the intersections of said display electrodes and said address electrodes, phosphorous layers with a specified order in red, green and blue on the rear panel and between adjacent of said barrier ribs, wherein serial red, green and blue cells form a pixel, and characterized by each of said display electrodes on said front panel over one pixel comprising:
a first and second transparent electrodes parallel to and away from each other;
a first and second auxiliary electrodes formed on said first and second transparent electrodes respectively;
at least a protrusion protruded from at least one of said auxiliary electrodes over cells; and
at least a protrusion protruded from at least one of said transparent electrodes over cells.

8. The plasma display panel according to claim 7, wherein said protrusions from said auxiliary electrodes over two cells in a pixel are same or different.

9. The plasma display panel according to claim 7, wherein said protrusions from said auxiliary electrodes over three cells in a pixel are same or different.

10. The plasma display panel according to claim 7, wherein said protrusions from said transparent electrodes over two cells in a pixel are same or different.

11. The plasma display panel according to claim 7, wherein said protrusions from said transparent electrodes over three cells in a pixel are same or different.
